(19) United States
(12) Patent Application Publication
(10) Pub. No.: US 2023/0202061 A1
(43) Pub. Date: Jun. 29, 2023

(54) RETRACTABLE KNIFE WITH SPEED ENHANCEMENT TRANSMISSION MECHANISM FOR ENHANCED SPEED OF DISCHARGING AND WITHDRAWING A BLADE THEREOF

(71) Applicant: Liqiou XU, Yangchun (CN)

(72) Inventor: Liqiou XU, Yangchun (CN)

(21) Appl. No.: 18/114,991

(22) Filed: Feb. 28, 2023

(30) Foreign Application Priority Data
Dec. 6, 2022 (CN) 202223255650.X

(51) Int. Cl. B26B 1/08

(52) U.S. Cl. CPC B26B 1/08

(57) ABSTRACT

A retractable knife, having a handle formed with an accommodating space which has an opening at one end of the handle; a side surface of the handle has a first sliding groove communicated with the accommodating space and a first rack corresponding to the first sliding groove; a blade is movably mounted in the accommodating space through the opening of the accommodating space; a second rack is arranged on the blade; a push button assembly is movably mounted on the first sliding groove and connected to the blade; the push button assembly can push the blade to move; the push button assembly has a gear engaged with the first rack and the second rack to form a speed enhancement transmission mechanism. A longer stroke of the blade during discharge and withdrawal can be achieved by a shorter stroke of the push button, thereby facilitating one-hand operation for convenient use.

### BACKGROUND OF THE INVENTION

The present utility model belongs to the field of knives, and in particular relates to a retractable knife with a speed enhancement transmission mechanism for enhanced speed of discharging and withdrawing a blade thereof.

A retractable knife is a knife in which a blade is discharged and withdrawn in a retractable mode. A common retractable knife in the market is a utility knife in which a push button is directly fixed on a blade, the blade is discharged and withdrawn by pushing or pulling back the push button, and a stroke of the push button is consistent with that of the blade; in order to fully discharge the blade, the push button needs to be fully pushed to move a distance corresponding to a distance required to be moved by the blade in order to be fully discharged; and for some retractable knives with a longer length, the push button needs to be pushed to move for a longer stroke, which is difficult for one hand to achieve blade discharging or blade withdrawing and is inconvenient to use.

Therefore, a retractable knife with a speed enhancement transmission mechanism which can achieve a longer stroke of the blade during blade discharging or blade withdrawing by a shorter stroke of the push button is urgently needed.

### BRIEF SUMMARY OF THE INVENTION

In view of the shortcomings in the prior art, the present utility model is intended to provide a retractable knife which can achieve a longer stroke of the blade during blade discharging or blade withdrawing by a shorter stroke of the push button, in order to facilitate one-hand operation for the sake of convenience.

In order to achieve the above objective, the present utility model adopts the following technical schemes:

A retractable knife, comprising:

a handle; wherein an accommodating space is formed in the handle; an opening of the accommodating space is positioned at one end of the handle; a side surface of the handle is provided with a first sliding groove in communication with the accommodating space and a first rack corresponding to an opening of the first sliding groove;

a blade movably mounted in the accommodating space through an opening end of the accommodating space; wherein a second rack is arranged on the blade; and

a push button assembly movably mounted at the first sliding groove and connected to the blade; wherein the push button assembly moves the blade when being driven to move; the push button assembly comprises a gear; the gear is engaged with the first rack and the second rack to form a speed enhancement transmission mechanism.

Further, the push button assembly also comprises a push button slidably arranged above the first sliding groove, and a sliding rod connected to the push button; the gear rotatably sleeves on the sliding rod.

Further, limiting grooves are arranged on the gear; limiting protrusions corresponding to the limiting grooves are arranged on the sliding rod; an elastic member is further provided on the push button, when the limiting protrusions engage with the limiting grooves, the gear is prevented from rotation on the sliding rod; when the push button is pressed, the elastic member is compressed, and the sliding rod moves axially and causes the limiting protrusions to disengage from the limiting grooves.

Further, the sliding rod comprises a first rod part, a second rod part, and a third rod part sequentially connected; the first rod part is connected with the push button, the second rod part is sleeved by the gear, and the third rod part has a diameter larger than that of the second rod part to limit the gear so that the gear does not disengage from the third rod part.

Further, the first rod part has a diameter smaller than that of the second rod part; a plurality of the limiting protrusions are arranged around an edge of a connection position of the first rod part and the second rod part and around an edge of a connection position of the second rod part and the third rod part; a plurality of the limiting grooves corresponding to the limiting protrusions are arranged around an interior surface of the gear.

Further, the push button comprises a push piece and a button arranged at a middle position of the push piece; the button is connected to the sliding rod; the elastic member is provided on the push button, the push piece causes the sliding rod to move along a lengthwise direction of the handle when being driven; the button presses the sliding rod when being driven, causing the sliding rod to move axially.

Further, a second sliding groove penetrating through the blade is arranged on the blade; the second rack is positioned on one inner side surface of the second sliding groove.

Further, a third sliding groove corresponding to the first sliding groove is arranged on another side surface of the handle opposite to the side surface of the handle provided with the first sliding groove; the push button assembly passes through the first sliding groove and the second sliding groove and reaches the third sliding groove.

Further, the gear comprises a first gear and a second gear coaxially arranged and fixed with each other; the first gear is engaged with the first rack; the second gear is engaged with the second rack.

Further, a gear ratio of the first gear to the second gear is less than one.

Beneficial Effects:

According to the present utility model, by arranging the first rack on the handle and the second rack on the blade, and connecting the push button assembly to the handle and the blade, when the push button assembly is pushed to slide, the gear can rotate while sliding, thereby driving the blade to move at an enhanced speed and achieving blade discharging or blade withdrawing at enhanced speed; by arranging limiting protrusions and limiting grooves, when the limiting protrusions engage with the limiting grooves, the gear cannot rotate on the sliding rod, thereby achieving position locking; by arranging the elastic member, the limiting protrusions are biased to engage with the limiting grooves, thereby ensuring safety of use; the limiting protrusions and the limiting grooves facilitate the push button assembly to be conveniently locked at any position when the push button assembly moves, accordingly, the blade can also be conveniently locked at any position, so that use is convenient. In the present utility model, a longer stroke of the blade during blade discharging or blade withdrawing can be achieved by a shorter stroke of the push button, which is convenient for one hand operation and is convenient to use.

### BRIEF DESCRIPTION OF THE DRAWINGS

FIG. 1 is a schematic diagram of a structure according to the present utility model;

FIG. 2 is a schematic diagram of an exploded structure according to the present utility model;

FIG. 3 is a schematic structural diagram of a gear according to the present utility model;

FIG. 4 is a schematic structural diagram of a sliding rod according to the present utility model;

FIG. 5 is a cross-sectional view of the blade protruded according to the present utility model;

FIG. 6 is another cross-sectional view of the blade protruded according to the present utility model;

FIG. 7 is an enlarged view of portion A in FIG. 6 according to the present utility model;

FIG. 8 is a cross-sectional view of the blade withdrawn according to the present utility model;

FIG. 9 is an enlarged view of portion B in FIG. 8 according to the present utility model; and

FIG. 10 is a partial schematic structural diagram of another embodiment according to the present utility model.

Numerals in the drawings: 1: handle, 110: accommodating space, 111: opening end, 120: first sliding groove, 130: first rack, and 140: third sliding groove; 2: blade, 210: second rack, 220: second sliding groove; 3: push button assembly, 310: gear, 311: limiting grooves, 312: first gear, 313: second gear, 320: push button, 321: push piece, 322: button, 330: sliding rod, 331: first rod part, 332: second rod part, 333: third rod part, 334: limiting protrusions, and 340: elastic member.

### DETAILED DESCRIPTION OF THE INVENTION

Embodiments of the present utility model are described in details below, with preferred examples being illustrated in the accompanying drawings, where the same or similar reference numerals indicate the same or similar elements or elements having the same or similar functions throughout all the drawings. The embodiments described below with reference to the accompanying drawings are exemplary, and are intended to explain the present utility model, and should not be construed as a limitation to the present utility model.

In the description of the present utility model, it should be understood that orientations or positional relationships indicated by the terms “length”, “width”, “upper”, “lower”, “front”, “rear”, “left”, “right”, “vertical”, “horizontal”, “top”, “bottom”, “inner”, “outer”, and the like are orientations or positional relationships as shown in the drawings, and are only for the purpose of facilitating and simplifying the description of the present utility model instead of indicating or implying that devices or elements indicated must have particular orientations, or be constructed and operated in the particular orientations. Such terms shall not be construed as limiting the present utility model.

In addition, the terms “first” and “second” are only for the purpose of description, and may not be construed as indicating or implying the relative importance or implicitly indicating the number of technical features indicated. Thus, features defined by “first” and “second” may explicitly or implicitly include one or more of that feature. In the description of the present utility model, “plurality” refers to two or more, unless otherwise explicitly and specifically defined.

In the embodiments of the present utility model, unless otherwise explicitly specified and limited, the terms such as “mount”, “connect”, “link”, “fix” and the like should be interpreted in a broad sense. For example, it may be a fixed connection, a detachable connection or integration; may be a mechanical connection or an electric connection; or may be a direct connection, an indirect connection by means of an intermediate, an internal interconnection of two elements or an interaction of two elements. For those of ordinary skill in the art, the specific meanings of the above terms in the present utility model can be construed according to specific situations.

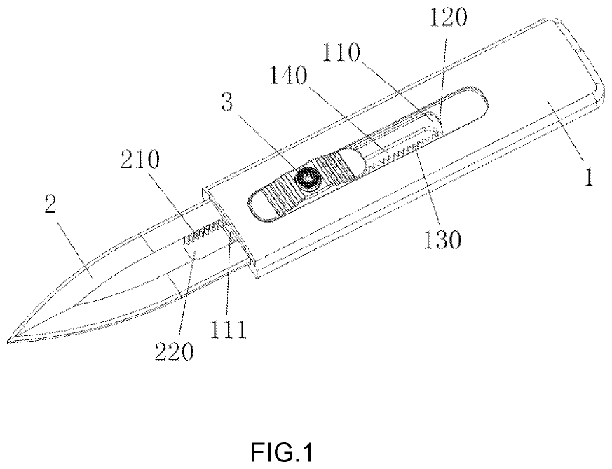

Referring to FIGS. 1 to 10, specific embodiments of a retractable knife provided by the present utility model is shown.

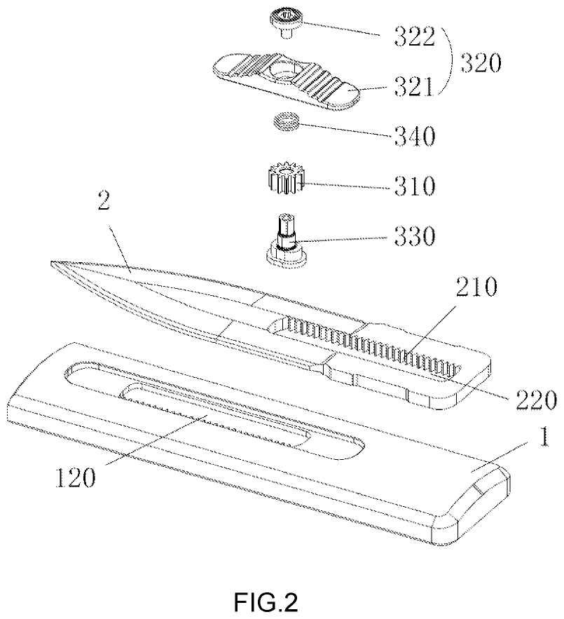

Referring to FIGS. 1 and 2, the retractable knife comprises:

a handle 1, wherein an accommodating space 110 is formed in the handle 1, an opening of the accommodating space 110 is positioned at one end of the handle 1, a side surface of the handle 1 is provided with a first sliding groove 120 communicated with the accommodating space 110 and a first rack 130 corresponding to an opening of the first sliding groove 120;

a blade 2 movably mounted in the accommodating space 110 through an opening end 111 of the accommodating space 110, wherein a second rack 210 is arranged on the blade 2; and

a push button assembly 3 movably mounted at the first sliding groove 120 and connected to the blade 2, wherein the push button assembly 3 can push the blade 2 to move; the push button assembly 3 comprises a gear 310, and the gear 310 is engaged with the first rack 130 and the second rack 210 to form a speed enhancement transmission mechanism.

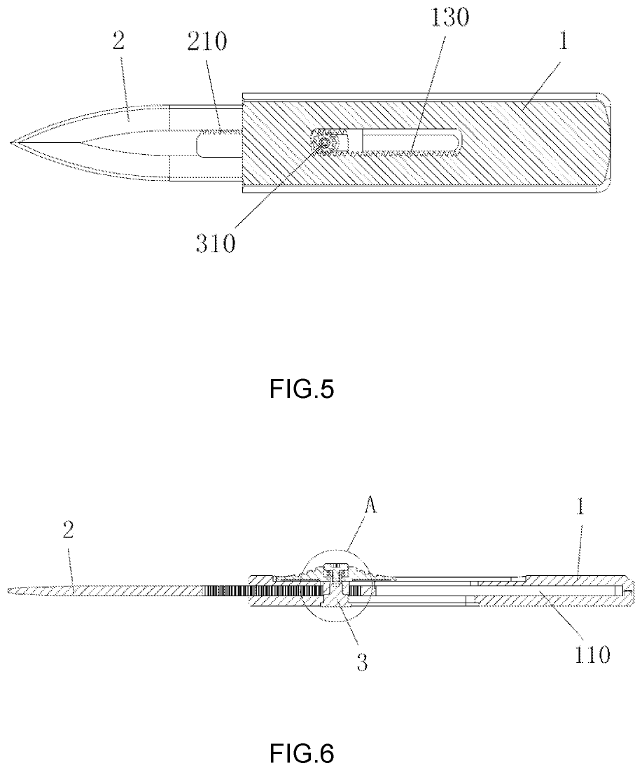

Referring to FIGS. 2 and 5, according to an embodiment, when the push button assembly 3 is pushed to move towards the opening end 111, the blade 2 protrudes from the opening end 111. Since the first rack 130 is engaged with the gear 310, the gear 310 rotates synchronously when the push button assembly 3 moves, since the gear 310 is also engaged with the second rack 210 at the same time, the blade 2 on one hand is moved synchronously with forward movement of the push button assembly 3 towards the opening end 111, and on the other hand will also be moved by the rotation of the gear 310 driving the second rack 210 to protrude forward. According to common knowledge of conventional gear and rack, a rotation stroke of the gear 310 is equal to a linear distance the gear 310 travels on the second rack 210 due to rotation of the gear 310, therefore, when the push button assembly 3 is pushed, the second rack 210 is driven to travel by a total distance which is two times the linear distance travelled by the gear 310. Since the gear 310 is positioned on the push button assembly 3 and the second rack 210 is positioned on the blade 2, when the push button assembly 3 is pushed, a distance travelled by the blade 2 is two times a distance travelled by the push button assembly 3, and the blade 2 and the push button assembly 3 move towards the same direction. Specifically, toothed surfaces of the first rack 130 and the second rack 210 are oppositely arranged, the gear 310 is positioned between the first rack 130 and the second rack 210, and the first rack 130 is parallel to the second rack 210.

Referring to FIG. 2, according to an embodiment, the push button assembly 3 comprises a push button 320 slidably arranged above the first sliding groove 120, and a sliding rod 330 connected to the push button 320; the gear 310 rotatably sleeves the sliding rod 330. In the embodiment, when the push button 320 is pushed, the sliding rod 330 moves along a lengthwise direction of the first sliding groove 120, the gear 310 sleeving the sliding rod 330 rotates simultaneously due to engagement with the first rack 130.

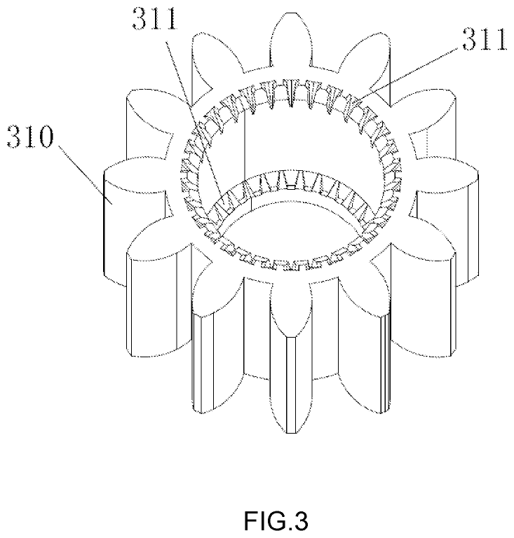

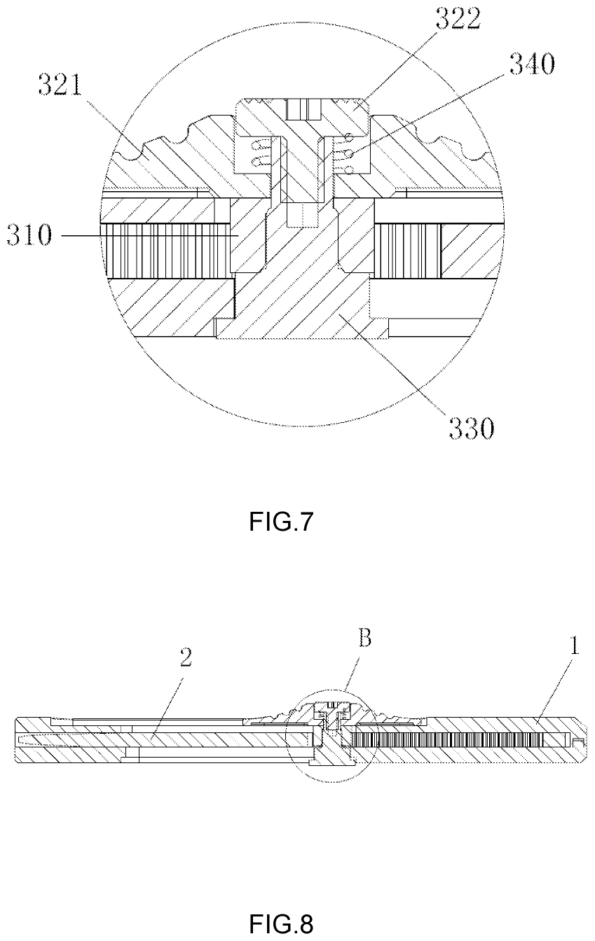

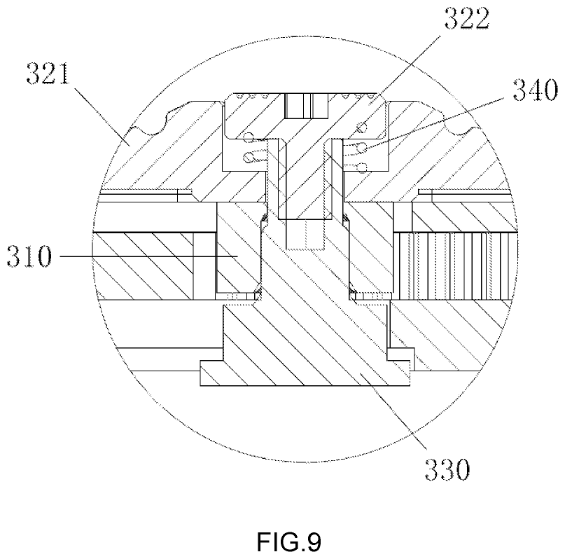

Referring to FIG. 3, according to an embodiment, limiting grooves 311 are arranged on the gear 310, limiting protrusions 334 corresponding to the limiting grooves 311 are arranged on the sliding rod 330, an elastic member 340 is further arranged on the push button 320, when the limiting protrusions 334 engage with the limiting grooves 311, the gear 310 cannot rotate on the sliding rod 330. When the push button 320 is pressed, the elastic member 340 is compressed, and the sliding rod 330 moves axially and causes the limiting protrusions 334 to disengage from the limiting grooves 311. In the embodiment, in order to prevent the blade 2 from discharging immediately and causing danger when the push button 320 is accidentally pushed, the elastic member 340 is preferably arranged between the push button 320 and the gear 310, so that the push button 320 is biased away from the gear 310 under the elastic force of the elastic member 340; since the push button 320 is connected to the sliding rod 330, corresponding limiting protrusions 334 and limiting grooves 311 may be arranged at a connection position between the sliding rod 330 and the gear 310, and the limiting protrusions 334 engage with the limiting grooves 311 under the elastic force, that is to say, the sliding rod 330 and the gear 310 are fixed with respect to each other, as shown in FIGS. 6 and 7. When the sliding rod 330 and the gear 310 are fixed with respect to each other, since the gear 310 is engaged with the first rack 130, and the gear 310 cannot rotate because it is fixed with the sliding rod 330, accordingly, the gear 310 cannot rotate or translate linearly on the first rack 130, meaning that the push button 320 cannot be pushed even if a user tries to push it, as such, the gear 310 is in a locked state, thereby ensuring safety of use. When the blade 2 needs to be used, press the push button 320 so that the sliding rod 330 is pressed downwardly, the elastic member 340 is compressed, and the limiting protrusions 334 on the sliding rod 330 are disengaged from the limiting grooves 311 on the gear 310, accordingly, the gear 310 is in an unlocked state and can rotate on the sliding rod 330, and therefore, the blade 2 can be discharged and withdrawn, as shown in FIGS. 8 and 9. Furthermore, during the process of withdrawing the blade 2 in the accommodating space 110 of the handle 1 or discharging the blade 2 from the opening end 111, or after the blade is fully discharged, the blade 2 can be locked at any desired position as long as the limiting protrusions 334 engage with the limiting grooves 311, so that the blade 2 can protrude to a proper length according to the use requirement. In the present embodiment, the elastic member 340 is a spring.

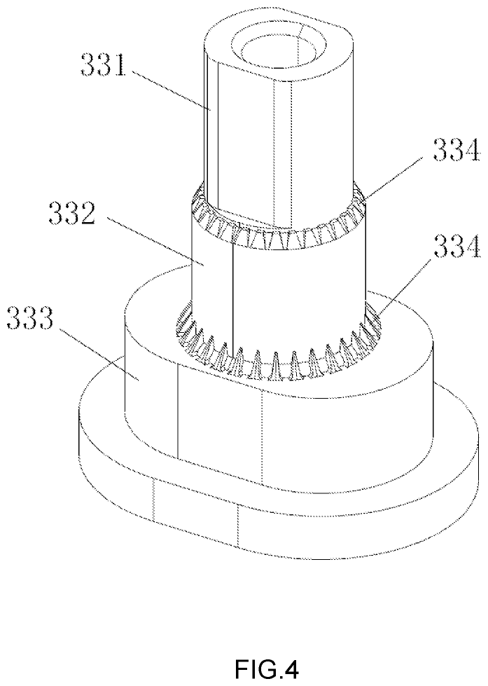

Referring to FIGS. 3 and 4, according to an embodiment, the sliding rod 330 comprises a first rod part 331, a second rod part 332 and a third rod part 333 sequentially connected, the first rod part 331 is connected with the push button 320, the second rod part 332 is sleeved by the gear 310, and the third rod part 333 has a diameter larger than that of the second rod part 332 to limit the gear 310, so that the gear 310 cannot be disengaged from the third rod part 333. The first rod part 331 has a diameter smaller than that of the second rod part 332, a plurality of the limiting protrusions 334 are arranged around an edge of a connection position of the first rod part 331 and the second rod part 332, a plurality of the limiting protrusions 334 are also arranged around an edge of a connection position of the second rod part 332 and the third rod part 333, and a plurality of the limiting grooves 311 corresponding to the limiting protrusions 334 are arranged around an interior surface of the gear 310. In the embodiment, by providing the plurality of limiting protrusions 334 and the plurality of limiting grooves 311, alignment of the limiting protrusions 334 and the limiting grooves 311 can be achieved when the gear 310 rotates on the sliding rod 330 at a certain angle, and locking of the gear 310 and thus the blade 2 can be achieved by releasing an external pressing force on the push button 320. The plurality of limiting protrusions 334 and the plurality of limiting grooves 311 are evenly arranged, and their quantities are sufficient enough to allow the blade 2 to be locked at any length it is discharged, thereby expanding use scenarios and improving user experience. Specifically, in the present embodiment, thirty limiting protrusions 334 are arranged around the edge of the connection position of the first rod part 331 and the second rod part 332, and thirty limiting protrusions 334 are arranged around the edge of the connection position of the second rod part 332 and the third rod part 333, so that alignment of the limiting protrusions 334 and the limiting grooves 311 can be achieved once when the gear 310 rotates by 12°.

Referring to FIGS. 6 to 9, in the above embodiment, the push button 320 comprises a push piece 321 and a button 322 arranged at a middle position of the push piece 321, the button 322 is connected to the sliding rod 330, the elastic member 340 is arranged between the button 322 and the push piece 321, the push piece 321 is configured to push the sliding rod 330 to move along a lengthwise direction of the handle 1, and the button 322 is configured to press the sliding rod 330 to move along an axial direction. In the embodiment, the button 322 is arranged at a middle position of the push piece 321, and when the blade 2 needs to be pushed out or withdrawn, the button 322 at the middle position of the push piece 321 needs to be pressed to unlock the gear 310 and move the push piece 321, so that accidental unlocking is prevented when only the push piece 321 is driven to move, thereby further improving safety. Meanwhile, the elastic member 340 is arranged between the button 322 and the push piece 321, so that the elastic member 340 can be prevented from directly abutting against the gear 310 which may otherwise affect the rotation of the gear 310.

Referring to FIG. 1, in the above embodiment, a second sliding groove 220 penetrating through the blade 2 is arranged on the blade 2, the second rack 210 is positioned on one inner side surface of the second sliding groove 220, a third sliding groove 140 corresponding to the first sliding groove 120 is arranged on another side surface of the handle 1 opposite to the side surface of the handle 1 provided with the first sliding groove 120; the push button assembly 3 passes through the first sliding groove 120 and the second sliding groove 220 and reaches the third sliding groove 140. In the embodiment, the push button 320 is positioned corresponding to the first sliding groove 120, the sliding rod 330 passes through the first sliding groove 120 and the second sliding groove 220 and reaches the third sliding groove 140, wherein the third rod part 333 of the sliding rod 330 is positioned corresponding to the third sliding groove 140.

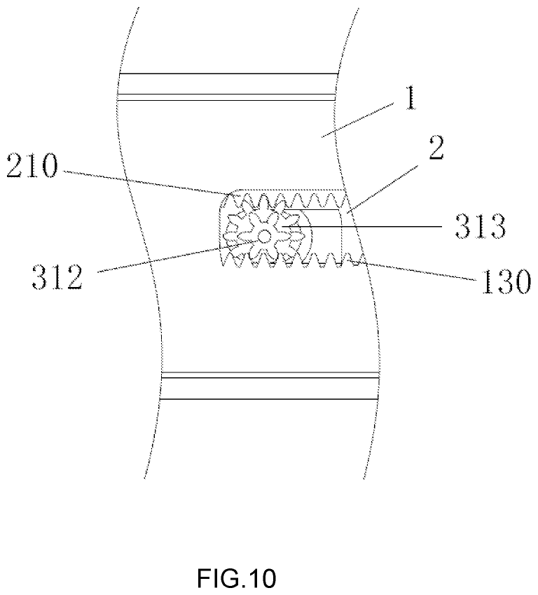

Referring to FIG. 10, according to an embodiment, the gear 310 comprises a first gear 312 and a second gear 313 coaxially arranged and fixed with each other, the first gear 312 is engaged with the first rack 130, the second gear 313 is engaged with the second rack 210, and a gear ratio of the first gear 312 to the second gear 313 is less than one. Optionally, a number of teeth of the second gear 313 may be twice that of the first gear 312, and so a moving distance of the blade 2 is three times that of the push button 320 when the push button 320 is pushed to drive the gear 310 to move and rotate.

In summary, the present utility model provides a retractable knife, wherein by arranging a first rack 130 on a handle 1 and a second rack 210 on a blade 2, and connecting a push button assembly 3 to the handle 1 and the blade 2, when the push button assembly 3 is pushed to slide, the gear 310 can rotate while sliding, thereby driving the blade 2 to move at an enhanced speed and achieving blade discharging or blade withdrawing at an enhanced speed; by arranging limiting protrusions 334 and limiting grooves 311, when the limiting protrusions 334 engage with the limiting grooves 311, the gear 310 cannot rotate on the sliding rod 330, thereby achieving position locking; an elastic member 340 is arranged, so that the limiting protrusions 334 are biased to engage with the limiting grooves 311, and thereby ensuring safety of use; the limiting protrusions 334 and the limiting grooves 311 are arranged so that the push button assembly 3 can be conveniently locked at any position when the push button assembly 3 moves, accordingly, the blade can also be conveniently locked at any position, so that use is convenient. In the present utility model, a longer stroke of the blade during blade discharging or blade withdrawing can be achieved by a shorter stroke of the push button 320, which is convenient for one hand operation and is convenient to use.

The above-mentioned embodiments are only a part of the preferred specific embodiments of the present utility model, and general changes and substitutions by those skilled in the art within the scope of the technical scheme of the present utility model shall fall within the protection scope of the present utility model.

What is claimed is:

1. A retractable knife, comprising:
a handle; wherein an accommodating space is formed in the handle; an opening of the accommodating space is positioned at one end of the handle; a side surface of the handle is provided with a first sliding groove in communication with the accommodating space and a first rack corresponding to an opening of the first sliding groove;
a blade movably mounted in the accommodating space through an opening end of the accommodating space; wherein a second rack is arranged on the blade; and
a push button assembly movably mounted at the first sliding groove and connected to the blade; wherein the push button assembly moves the blade when being driven to move; the push button assembly comprises a gear; the gear is engaged with the first rack and the second rack to form a speed enhancement transmission mechanism.

2. The retractable knife of claim 1, wherein the push button assembly also comprises a push button slidably arranged above the first sliding groove, and a sliding rod connected to the push button; the gear rotatably sleeves on the sliding rod.

3. The retractable knife of claim 2, wherein limiting grooves are arranged on the gear; limiting protrusions corresponding to the limiting grooves are arranged on the sliding rod; an elastic member is further arranged on the push button, when the limiting protrusions engage with the limiting grooves, the gear is prevented from rotation on the sliding rod; when the push button is pressed, the elastic member is compressed, and the sliding rod moves axially and causes the limiting protrusions to disengage from the limiting grooves.

4. The retractable knife of claim 3, wherein the sliding rod comprises a first rod part, a second rod part, and a third rod part sequentially connected; the first rod part is connected with the push button, the second rod part is sleeved by the gear, and the third rod part has a diameter larger than that of the second rod part to limit the gear so that the gear does not disengage from the third rod part.

5. The retractable knife of claim 4, wherein the first rod part has a diameter smaller than that of the second rod part; a plurality of the limiting protrusions are arranged around an edge of a connection position of the first rod part and the second rod part and around an edge of a connection position of the second rod part and the third rod part; a plurality of the limiting grooves corresponding to the limiting protrusions are arranged around an interior surface of the gear.

6. The retractable knife of claim 3, wherein the push button comprises a push piece and a button arranged at a middle position of the push piece; the button is connected to the sliding rod; the elastic member is arranged between the button and the push piece, the push piece causes the sliding rod to move along a lengthwise direction of the handle when being driven; the button presses the sliding rod when being driven, causing the sliding rod to move axially.

7. The retractable knife of claim 1, wherein a second sliding groove penetrating through the blade is arranged on the blade; the second rack is positioned on one inner side surface of the second sliding groove.

8. The retractable knife of claim 7, wherein a third sliding groove corresponding to the first sliding groove is arranged on another side surface of the handle opposite to the side surface of the handle provided with the first sliding groove; the push button assembly passes through the first sliding groove and the second sliding groove and reaches the third sliding groove.

9. The retractable knife of claim 1, wherein the gear comprises a first gear and a second gear coaxially arranged and fixed with each other; the first gear is engaged with the first rack; the second gear is engaged with the second rack.

10. The retractable knife of claim 9, wherein a gear ratio of the first gear to the second gear is less than one.
